(19) United States
(12) Patent Application Publication
(10) Pub. No.: US 2024/0043658 A1
(43) Pub. Date: Feb. 8, 2024

(54) Gel Extruded Articles With Molecular Weight Retention

(71) Applicant: Celanese International Corporation, Irving, TX (US)

(72) Inventors: Christian Ohm, Gernsheim (DE); David Ditter, Mainz (DE)

(21) Appl. No.: 18/358,523

(22) Filed: Jul. 25, 2023

Related U.S. Application Data
(60) Provisional application No. 63/392,930, filed on Jul. 28, 2022.

(51) Int. Cl. C08K 5/524; C08K 5/12; H01M 50/417; C08J 7/04

(52) U.S. Cl. CPC C08K 5/524; C08K 5/12; H01M 50/417; C08J 7/0427; C08K 2201/014; C08J 2323/06

(57) ABSTRACT

A polymer composition is disclosed that is particularly formulated for producing gel extruded articles containing a high density polyethylene polymer. In one embodiment, the polymer composition is used to produce a porous membrane or film well suited for use as an ion separator in an electronic device, such as a battery. The polymer composition contains a molecular weight retention package that preserves the molecular weight of the polyethylene polymer during extrusion.

### RELATED APPLICATIONS

The present application is based upon and claims priority to U.S. Provisional Patent Application Ser. No. 63/392,930, having a filing date of Jul. 28, 2022, which is incorporated herein by reference.

### BACKGROUND

Polyethylene polymers have numerous and diverse uses and applications. For example, high density polyethylenes are valuable engineering plastics, with a unique combination of abrasion resistance, surface lubricity, chemical resistance and impact strength. They find application in the production of high strength fibers for use in ropes and anti-ballistic shaped articles and in the production of other elongated articles, such as membranes for lithium batteries. However, since the flowability of these materials in the molten state decreases as the molecular weight increases, processing by conventional techniques, such as melt extrusion, is not always possible.

One alternative method for producing fibers and other elongated components from polyethylene polymers is by gel-processing in which the polymer is combined with a solvent. The resultant gel is extruded into a fiber or membrane, and may be stretched in one or two directions. More particularly, the high molecular weight polyethylene resin is combined with a process solvent using heat and mechanical mixing to form a gel. The resulting gel is then shaped into a sheet using, for instance, a T-die. Upon rapid cooling, the polyethylene polymer phase separates from the process solvent and the article or membrane solidifies into a gel-sheet. The gel-sheet can be stretched in both the machine direction and the transverse direction and the process solvent is removed by a washing step with an extraction solvent.

One common issue or problem experienced in gel extruding high molecular weight polyethylene is that the polymer has a tendency to degrade due to the heat and shear generated during the process. As degradation can cause extruded products to have a lower molecular weight compared to the unprocessed polyethylene resin, the reduction in molecular weight is typically paired with a reduction in mechanical strength. Especially when producing porous membranes for lithium ion batteries, preserving the molecular weight and/or strength of the high molecular weight polyethylene polymer preserves the overall performance characteristics of the membrane.

During processing or gel extrusion of high molecular weight polyethylene polymers, the polymers also have a tendency to form carbon-oxygen bonds. These bonds are easily susceptible to oxidation during use of the product. When incorporated into a lithium ion battery, the presence of the carbon-oxygen bonds can cause a reduction in battery lifetime.

In view of the above, a need currently exists for a high molecular weight polyethylene polymer composition that can be gel processed without the polyethylene polymer degrading in molecular weight and/or strength. A need also exists for a polymer composition containing a high molecular weight polyethylene polymer that can be gel extruded while inhibiting the formation of carbon-oxygen bonds.

### SUMMARY

In general, the present disclosure is directed to polymer compositions well suited for gel processing applications. More particularly, the present disclosure is directed to a polymer composition containing a high molecular weight and a high density polyethylene polymer that is combined with one or more additives such that the polymer properties are preserved during gel processing applications when producing various articles, such as porous membranes for use in batteries. For example, the polymer composition can be formulated so that molecular weight degradation of the polyethylene polymer is inhibited during gel processing. Polymer articles can be formed, such as porous membranes, that have better preserved strength properties.

For example, in one embodiment, the present disclosure is directed to a polymer composition for producing gel extruded articles. The polymer composition comprises a plasticizer blended with particles formed from a high density and high molecular weight polyethylene polymer. In one embodiment, the polyethylene polymer can have a molecular weight of greater than about 300,000 g/mol, such as greater than about 400,000 g/mol, such as greater than about 500,000 g/mol, such as greater than about 600,000 g/mol. The high density polyethylene polymer is combined with the plasticizer in the presence of a molecular weight retention package that is well suited to producing a gel-like composition capable of being extruded. In accordance with the present disclosure, the molecular weight retention package comprises a hindered phenolic compound and a phosphite compound. The molecular weight retention package is present in the polymer composition in an amount sufficient so that an extracted porous membrane gel extruded from the composition displays an intrinsic viscosity retention of greater than about 88% in comparison to the intrinsic viscosity of the high density polyethylene polymer prior to extrusion. For example, the molecular weight retention package can be present in the polymer composition such that the composition displays an intrinsic viscosity retention of greater than about 90%, such as greater than about 92%, such as even greater than about 94%.

In one aspect, the phosphite compound can be present in the polymer composition in an amount greater than about 500 ppm, such as in an amount greater than about 700 ppm, such as in an amount greater than about 900 ppm, such as in an amount greater than about 1,100 ppm, such as in an amount greater than about 1,300 ppm, such as in an amount greater than about 1,500 ppm, such as in an amount greater than about 1,700 ppm, such as in an amount greater than about 1,900 ppm, and generally less than about 5,000 ppm. The hindered phenolic compound, on the other hand, can be present in an amount greater than about 1,000 ppm, such as in an amount greater than about 1,200 ppm, such as in an amount greater than about 1,400 ppm, such as in an amount greater than about 1,600 ppm, such as in an amount greater than about 1,800 ppm, such as in an amount greater than about 2,000 ppm, such as in an amount greater than about 2,200 ppm, such as in an amount greater than about 2,400 ppm, such as in an amount greater than about 2,600 ppm, such as in an amount greater than about 2,800 ppm, such as in an amount greater than about 3,000 ppm, such as in an amount greater than about 3,200 ppm, such as in an amount greater than about 3,400 ppm, such as in an amount greater than about 3,600 ppm, such as in an amount greater than about 3,800 ppm, and generally in an amount less than about 7,000 ppm. The phosphite compound, for instance, can comprise 2,2′-methylene bis(4,6-di-tert-butyl-phenyl)-2-ethylhexyl phosphite. The hindered phenolic compound, on the other hand, can comprise pentaerythritol tetrakis (3-(3,5-di-tert-butyl-4-hydroxyphenyl)propionate). In one embodiment, the weight ratio between the phosphite compound and the hindered phenolic compound can be from about 1:1 to about 1:3, such as from about 1:1.5 to about 1:2.5.

In general, the polymer composition contains the high density polyethylene resin in an amount up to about 50% by weight. The plasticizer, for instance, can be present in the composition in an amount greater than about 50% by weight, such as in an amount greater than about 60% by weight, such as in an amount greater than about 70% by weight, such as in an amount greater than about 80% by weight, such as in an amount greater than about 90% by weight. Various different materials can be used as the plasticizer. For instance, the plasticizer may comprise a mineral oil, a paraffinic oil, a hydrocarbon oil, an alcohol, or the like. For instance, the plasticizer may comprise decaline, xylene, dioctyl phthalate, dibutyl phthalate, stearyl alcohol, oleyl alcohol, decyl alcohol, nonyl alcohol, diphenyl ether, n-decane, n-dodecane, or mixtures thereof. In one embodiment, the plasticizer may comprise a C5-C12 hydrocarbon, such as a C5-C12 saturated hydrocarbon. For example, the plasticizer may comprise heptane, hexane, or the like.

The present disclosure is also directed to polymer articles formed from the above polymer composition. The polymer articles can be produced through a gel extrusion process. Polymer articles made in accordance with the present disclosure include fibers, films, and particularly porous membranes for electronic devices, such as lithium ion batteries. Once gel extruded, the high density and high molecular weight polyethylene polymer present in the article can have an intrinsic viscosity of greater than about 850 cm³/g, such as greater than about 875 cm³/g, such as greater than about 900 cm³/g.

The present disclosure is also directed to a process for producing polymer articles. The process includes the steps of forming a gel-like composition from the polymer composition described above. The gel-like composition is then extruded through a die to form a polymer article. The polymer article, for instance, may comprise fibers, a film, or a membrane. During formation of the polymer article, at least part of the plasticizer is separated and removed from the polyethylene particle. For instance, in one embodiment, greater than 80%, such as greater than 90%, such as greater than 95%, such as greater than 98% of the plasticizer is removed during formation of the polymer article.

In one embodiment, an extraction solvent, such as dichloromethane is combined with the polymer composition before or during formation of the polymer article. The extraction solvent can be used to facilitate removal of the plasticizer.

Other features and aspects of the present disclosure are discussed in greater detail below.

### BRIEF DESCRIPTION OF THE DRAWINGS

The present disclosure may be better understood with reference to the following FIGURE:

FIG. 1 is a cross-sectional view of an electronic device, such as a battery, incorporating a porous membrane or film made in accordance with the present disclosure.

Repeat use of reference characters in the present specification and drawings is intended to represent the same or analogous features or elements of the present invention.

### Definitions

The melt flow rate of a polymer or polymer composition is measured according to ISO Test 1133 at 190° C. and at a load of 21.6 kg.

The density of a polymer is measured according to ISO Test 1183 in units of g/cm³.

Average particle size (d50) is measured using laser diffraction/light scattering, such as a suitable Horiba light scattering device.

The average molecular weight of a polymer is determined using the Margolies' equation.

Tensile modulus, tensile stress at yield, tensile strain at yield, tensile stress at 50% break, tensile stress at break, and tensile nominal strain at break are all measured according to ISO Test 527-2/1B.

The full width at half maximum of a melting endothermic peak of a sample is measured with a differential scanning calorimeter (DSC). An electronic balance is used to measure 8.4 g of a sample. The sample is placed in an aluminum sample pan. An aluminum cover is attached to the pan, which is set in the differential scanning calorimeter. The sample and a reference sample are retained at 40° C. for one minute while nitrogen purge is performed at a flow rate of mL/min then heated from 40° C. to 180° C. at a heating rate of 10° C./min, retained at 180° C. for 5 minutes, and then cooled to 40° C. at a cooling rate of 10° C./min. A baseline is drawn from 60° C. to 150° C. in the melting curve acquired during the process and the full width at half maximum of a melting endothermic peak is derived using analysis software, such as “Pyris Software (Version 7).” The test can be conducted using a DSC Q2000 calorimeter available from TA Instruments.

The half-crystallization period of time during an isothermal crystallization at 123° C. can be determined from the time that requires a quantity of heat measured during an isothermal crystallization measurement at 123° C. to correspond to the half of the peak area in differential scanning calorimetry (DSC) measurement. The test can be conducted using a DSC Q2000 calorimeter available from TA Instruments.

Contact angle measurements are performed on a Krüss DSA 100 instrument. A membrane sample (10×40 mm) is attached to a microscope slide using double sided adhesive tape. Static charging is dissipated by moving the prepared sample several times through a U-electrode static discharger. The sample is mounted in a measurement device and a 3.5 μl droplet of testing fluid (water or ethyleneglycol) is placed on the membrane. The contact angle is determined through the software for 7 seconds (one measurement per second) after placement of the droplet. These 7 data points are averaged to yield the contact angle at the point of measurement. Every sample is measured at 6 different spots or locations on each side and all results are averaged to the reported value.

A soaking test may be used to determine the wicking characteristics of membranes made in accordance with the present disclosure according to the following procedure.

For the soaking test a glass vessel is used with following dimensions: 20×10 cm upper area (covered with a metal plate)/19×8 cm lower area (base)/height: 10 cm). Two filter papers are sticked at the inside of the glass vessel with a tape. 300 ml propylene carbonate is filled into the vessel afterwards (fluid level: 2 cm). The vessel is covered with a metal plate and propylene carbonate is allowed to fill the gas space for 20 minutes.

Membranes are cut with scissors into pieces (length: 70 mm, width: 7 mm). This is done with nitrile gloves to prevent touching the membranes with the bare hand. The pieces are mounted on an anodized metal plate (140 mm×70 mm, frame width: 10 mm, slope: 80°) with the help of magnets. The MD direction of membranes shows upwards (=soaking direction).

The metal frame with the fixed membranes are then moved 40 times through a deionizer to remove electrostatic charges. After that the frame is placed into the vessel filled with propylene carbonate at room temperature and soaking of the membranes with propylene carbonates takes place for a desired time. During soaking takes place the vessel is closed with a metal plate. The different soaking distances of the membranes are measured every 30 minutes by taking a photo and measuring the distance with a suitable computer program.

Soaking distances of tested membranes is compared to draw conclusion on their battery electrolyte affinity.

Gurley permeability can be measured according to the Gurley Test, using a Gurley permeability tester, such as Gurley Densometer, Model KRK 2060c commercially available from Kumagai Riki Kogyo Co., LTD. The test is conducted according to ISO Test 5636. The Gurley Test measures air permeability as a function of the time required for a specified amount of air to pass through a specified area under a specified pressure. The units are reported in sec/100 ml.

Porosity (%) is measured according to the following procedure. During the procedure, the following ASTM Standards are used as a reference: D622 Standard Test Method for Apparent Density of Rigid Cellular Plastics1; and D729 Standard Test Methods for Density and Specific Gravity (Relative Density) of Plastics by Displacement1. The following instruments are used: Calibrated Analytical Balance (0.0001 grams); Lorentzen & Wettre Micrometer, code 251 (0.1 um); and Deli 2056 art knife.

### Procedure:

### 1.1. Samples and Sample Preparation

Using the specimen art knife, cut each sample material into a minimum of three 60 mm±0.5 by 60 mm±0.5 specimens

### 1.2. Instrument and Measurement

1.2.1 Using the L&W micrometer, take five readings of the thickness at each 60 mm by 60 mm specimen (average of 5 readings). Record this value as the thickness of this specimen.
1.2.2 Weigh the specimen directly on the balance. Record this value as the weight of this specimen.
1.2.3 The three specimens of the same sample are placed together and steps 1.2.1 and 1.2.2 are repeated to obtain the [bulk] thickness and the [bulk] weight.

Calculate the density to three significant figures as follows

Dfilm=Density(film)=Wt. of Specimen/THK*Square a.
Dfilm=density of specimen, (mg/mm3)
Wt=weight of specimen, (mg)
THK=thickness of specimen, (mm)
Square=area of specimen, (mm2)

Dpolymer=Density(polymer) 0.95 (g/cm³) b.
Dpolymer: Density of raw materials, without the pores.

Porosity=(1−Dfilm/Dpolymer)*100% c.

As used herein, puncture strength is measured according to ASTM Test D3763 and measures the ability of a membrane to withstand a foreign particle from causing a hole or defect. The test is conducted on a testing device, such as an Instron CEAST 9340 device. The drop height is 0.03 to 1.10 m. The impact velocity is 0.77 to 4.65 m/s. The maximum dropping mass is 37.5 kg and the maximum potential energy is 405 J. Puncture strength is measured in slow speed puncture mode at 1.67 mm/s. Puncture strength can be normalized by dividing by the thickness of the membrane resulting in units of mN/micron.

Heat shrinkage of a membrane is determined by putting a piece of membrane (3 in×3 in) in an oven at 105° C. for 1 h. Shrinkage is calculated by measuring the size in MD and TD direction before and after heat treatment.

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to a polymer composition well suited for producing gel extruded articles, particularly porous membranes for lithium ion batteries. The polymer composition contains a polyethylene resin, such as high density polyethylene particles, combined with a plasticizer and a molecular weight retention package. It was unexpectedly discovered that the molecular weight retention package can maintain the properties of the polyethylene resin even during the gel extrusion process, high shear forces and increased temperatures. The molecular weight retention package includes a hindered phenolic compound combined with a phosphite compound in selectively controlled amounts with respect to each other. In addition, the hindered phenolic compound and the phosphite compound are added to the polymer composition containing the polyethylene resin and the plasticizer at elevated levels for providing the advantages and benefits of the present disclosure.

As described above, articles made according to the present disclosure are formed from one or more high density polyethylene polymers. The high density polyethylene has a density of about 0.93 g/cm³ or greater, such as about g/cm³ or greater, such as about 0.95 g/cm³ or greater, and generally less than about 1 g/cm³, such as less than about 0.97 g/cm³.

The high density polyethylene polymer can be made from over 90% ethylene derived units, such as greater than 95% ethylene derived units, or from 100% ethylene derived units. The polyethylene can be a homopolymer or a copolymer, including a terpolymer, having other monomeric units.

The high density polyethylene can be a high molecular weight polyethylene, a very high molecular weight polyethylene, and/or an ultrahigh molecular weight polyethylene. “High molecular weight polyethylene” refers to polyethylene compositions with an average molecular weight of at least about 3×10⁵ g/mol and, as used herein, is intended to include very-high molecular weight polyethylene and ultra-high molecular weight polyethylene. For purposes of the present specification, the molecular weights referenced herein are determined in accordance with the Margolies equation (“Margolies molecular weight”).

“Very-high molecular weight polyethylene” refers to polyethylene compositions with a weight average molecular weight of less than about 3×10⁶ g/mol and more than about 1×10⁶ g/mol. In some embodiments, the molecular weight of the very-high molecular weight polyethylene composition is between about 2×10⁶ g/mol and less than about 3×10⁶ g/mol.

“Ultra-high molecular weight polyethylene” refers to polyethylene compositions with an average molecular weight of at least about 3×10⁶ g/mol. In some embodiments, the molecular weight of the ultra-high molecular weight polyethylene composition is between about 3×10⁶ g/mol and about 30×10⁶ g/mol, or between about 3×10⁶ g/mol and about 20×10⁶ g/mol, or between about 3×10⁶ g/mol and about 10×10⁶ g/mol, or between about 3×10⁶ g/mol and about 6×10⁶ g/mol.

In one aspect, the high density polyethylene is a homopolymer of ethylene. In another embodiment, the high density polyethylene may be a copolymer. For instance, the high density polyethylene may be a copolymer of ethylene and another olefin containing from 3 to 16 carbon atoms, such as from 3 to 10 carbon atoms, such as from 3 to 8 carbon atoms. These other olefins include, but are not limited to, propylene, 1-butene, 1-pentene, 1-hexene, 1-heptene, 1-octene, 4-methylpent-1-ene, 1-decene, 1-dodecene, 1-hexadecene and the like. Also utilizable herein are polyene comonomers such as 1,3-hexadiene, 1,4-hexadiene, cyclopentadiene, dicyclopentadiene, 4-vinylcyclohex-1-ene, 1,5-cyclooctadiene, 5-vinylidene-2-norbornene and 5-vinyl-2-norbornene. However, when present, the amount of the non-ethylene monomer(s) in the copolymer may be less than about 10 mol. %, such as less than about 5 mol. %, such as less than about 2.5 mol. %, such as less than about 1 mol. %, wherein the mol. % is based on the total moles of monomer in the polymer.

In one embodiment, the high density polyethylene may have a monomodal molecular weight distribution. Alternatively, the high density polyethylene may exhibit a bimodal molecular weight distribution. For instance, a bimodal distribution generally refers to a polymer having a distinct higher molecular weight and a distinct lower molecular weight (e.g. two distinct peaks) on a size exclusion chromatography or gel permeation chromatography curve. In another embodiment, the high density polyethylene may exhibit more than two molecular weight distribution peaks such that the polyethylene exhibits a multimodal (e.g., trimodal, tetramodal, etc.) distribution. Alternatively, the high density polyethylene may exhibit a broad molecular weight distribution wherein the polyethylene is comprised of a blend of higher and lower molecular weight components such that the size exclusion chromatography or gel permeation chromatography curve does not exhibit at least two distinct peaks but instead exhibits one distinct peak broader than the individual component peaks.

Any method known in the art can be utilized to synthesize the polyethylene. The polyethylene powder is typically produced by the catalytic polymerization of ethylene monomer or optionally with one or more other 1-olefin co-monomers, the 1-olefin content in the final polymer being less or equal to 10% of the ethylene content, with a heterogeneous catalyst and an organo aluminum or magnesium compound as cocatalyst. The ethylene is usually polymerized in gaseous phase or slurry phase at relatively low temperatures and pressures. The polymerization reaction may be carried out at a temperature of between 50° C. and 100° C. and pressures in the range of 0.02 and 2 MPa.

The molecular weight of the polyethylene can be adjusted by adding hydrogen. Altering the temperature and/or the type and concentration of the co-catalyst may also be used to fine tune the molecular weight. Additionally, the reaction may occur in the presence of antistatic agents to avoid fouling and product contamination.

Suitable catalyst systems include but are not limited to Ziegler-Natta type catalysts. Typically, Ziegler-Natta type catalysts are derived by a combination of transition metal compounds of Groups 4 to 8 of the Periodic Table and alkyl or hydride derivatives of metals from Groups 1 to 3 of the Periodic Table. Transition metal derivatives used usually comprise the metal halides or esters or combinations thereof. Exemplary Ziegler-Natta catalysts include those based on the reaction products of organo aluminum or magnesium compounds, such as for example but not limited to aluminum or magnesium alkyls and titanium, vanadium or chromium halides or esters. The heterogeneous catalyst might be either unsupported or supported on porous fine grained materials, such as silica or magnesium chloride. Such support can be added during synthesis of the catalyst or may be obtained as a chemical reaction product of the catalyst synthesis itself.

In one embodiment, a suitable catalyst system can be obtained by the reaction of a titanium(IV) compound with a trialkyl aluminum compound in an inert organic solvent at temperatures in the range of −40° C. to 100° C., preferably −20° C. to 50° C. The concentrations of the starting materials are in the range of to 9 mol/L, preferably 0.2 to 5 mol/L, for the titanium(IV) compound and in the range of 0.01 to 1 mol/L, preferably 0.02 to 0.2 mol/L for the trialkyl aluminum compound. The titanium component is added to the aluminum component over a period of 0.1 min to 60 min, preferably 1 min to 30 min, the molar ratio of titanium and aluminum in the final mixture being in the range of 1:0.01 to 1:4.

In another embodiment, a suitable catalyst system is obtained by a one or two-step reaction of a titanium(IV) compound with a trialkyl aluminum compound in an inert organic solvent at temperatures in the range of −40° C. to 200° C., preferably −20° C. to 150° C. In the first step the titanium(IV) compound is reacted with the trialkyl aluminum compound at temperatures in the range of −40° C. to 100° C., preferably −20° C. to 50° C. using a molar ratio of titanium to aluminum in the range of 1:0.1 to 1:0.8. The concentrations of the starting materials are in the range of 0.1 to 9.1 mol/L, preferably 5 to 9.1 mol/L, for the titanium(IV) compound and in the range of 0.05 and 1 mol/L, preferably 0.1 to 0.9 mol/L for the trialkyl aluminum compound. The titanium component is added to the aluminum compound over a period of 0.1 min to 800 min, preferably 30 min to 600 min. In a second step, if applied, the reaction product obtained in the first step is treated with a trialkyl aluminum compound at temperatures in the range of −10° C. to 150° C., preferably 10° C. to 130° C. using a molar ratio of titanium to aluminum in the range of 1:0.01 to 1:5.

In yet another embodiment, a suitable catalyst system is obtained by a procedure wherein, in a first reaction stage, a magnesium alcoholate is reacted with a titanium chloride in an inert hydrocarbon at a temperature of 50° to 100° C. In a second reaction stage the reaction mixture formed is subjected to heat treatment for a period of about 10 to 100 hours at a temperature of 110° to 200° C. accompanied by evolution of alkyl chloride until no further alkyl chloride is evolved, and the solid is then freed from soluble reaction products by washing several times with a hydrocarbon.

In a further embodiment, catalysts supported on silica, such as for example the commercially available catalyst system Sylopol 5917 can also be used.

Using such catalyst systems, the polymerization is normally carried out in suspension at low pressure and temperature in one or multiple steps, continuous or batch. The polymerization temperature is typically in the range of 30° C. to 130° C., preferably is the range of 50° C. and 90° C. and the ethylene partial pressure is typically less than 10 MPa, preferably 0.05 and 5 MPa. Trialkyl aluminums, like for example but not limited to isoprenyl aluminum and triisobutyl aluminum, are used as co-catalyst such that the ratio of Al:Ti (co-catalyst versus catalyst) is in the range of 0.01 to 100:1, more preferably is the range of 0.03 to 50:1. The solvent is an inert organic solvent as typically used for Ziegler type polymerizations. Examples are butane, pentane, hexane, cyclohexene, octane, nonane, decane, their isomers and mixtures thereof. The polymer molecular mass is controlled through feeding hydrogen. The ratio of hydrogen partial pressure to ethylene partial pressure is in the range of 0 to 50, preferably the range of 0 to 10. The polymer is isolated and dried in a fluidized bed drier under nitrogen. The solvent may be removed through steam distillation in case of using high boiling solvents. Salts of long chain fatty acids may be added as a stabilizer. Typical examples are calcium, magnesium and zinc stearate.

Optionally, other catalysts such as Phillips catalysts, metallocenes and post metallocenes may be employed. Generally, a cocatalyst such as alumoxane or alkyl aluminum or alkyl magnesium compound is also employed. Other suitable catalyst systems include Group 4 metal complexes of phenolate ether ligands.

Polyethylene polymers particularly well suited for use in the present disclosure have a full width at half maximum of a melting endothermic peak when measured with a differential scanning calorimeter of greater than about 6 degrees C., such as greater than about 6.2 degrees C., such as greater than about 6.4 degrees C., such as greater than about 6.5 degrees C., such as greater than about 6.8 degrees C., and generally less than about 9 degrees C. The polyethylene polymer can also have a half-crystallization time period during an isothermal crystallization at 123° C. of greater than about 2 minutes, such as greater than about 2.5 minutes, such as greater than about 3.0 minutes, such as greater than about 3.5 minutes, such as greater than about 4.0 minutes, such as greater than about 4.5 minutes, and generally less than about 12 minutes.

In accordance with the present disclosure, the high density polyethylene polymer is formed into particles and combined with a plasticizer and the molecular weight retention package of the present disclosure. In one embodiment, the polyethylene particles are made from a polyethylene polymer having a relatively low bulk density as measured according to DIN53466. For instance, in one embodiment, the bulk density is generally less than about 0.4 g/cm³, such as less than about 0.35 g/cm³, such as less than about 0.33 g/cm³, such as less than about 0.3 g/cm³, such as less than about 0.28 g/cm³, such as less than about 0.26 g/cm³. The bulk density is generally greater than about 0.1 g/cm³, such as greater than about 0.15 g/cm³. In one embodiment, the polymer has a bulk density of from about 0.2 g/cm³ to about 0.27 g/cm³.

In one embodiment, the polyethylene particles can be a free-flowing powder. The particles can have a median particle size (d50) by volume of less than 200 microns. For example, the median particle size (d50) of the polyethylene particles can be less than about 150 microns, such as less than about 125 microns. The median particle size (d50) is generally greater than about 20 microns. The powder particle size can be measured utilizing a laser diffraction method according to ISO 13320.

In one embodiment, 90% of the polyethylene particles can have a particle size of less than about 250 microns. In other embodiments, 90% of the polyethylene particles can have a particle size of less than about 200 microns, such as less than about 170 microns.

The molecular weight of the polyethylene polymer can vary depending upon the particular application. The polyethylene polymer, for instance, may have an average molecular weight, as determined according to the Margolies equation. The molecular weight can be determined by first measuring the viscosity number according to DIN EN ISO Test 1628. Dry powder flow is measured using a 25 mm nozzle. The molecular weight is then calculated using the Margolies equation from the viscosity numbers. The average molecular weight is generally greater than about 300,000 g/mol, such as greater than about 500,000 g/mol, such as greater than about 650,000 g/mol, such as greater than about 1,000,000 g/mol, such as greater than about 2,000,000 g/mol, such as greater than about 2,500,000 g/mol, such as greater than about 3,000,000 g/mol, such as greater than about 4,000,000 g/mol. The average molecular weight is generally less than about 12,000,000 g/mol, such as less than about 10,000,000 g/mol. In one aspect, the number average molecular weight of the high density polyethylene polymer can be less than about 4,000,000 g/mol, such as less than about 3,000,000 g/mol.

In one aspect, the composition or membrane can include only a single polyethylene polymer. The single polyethylene polymer can have an average molecular weight of 500,000 g/mol or greater, such as greater than about 600,000 g/mol and generally less than 2,500,000 g/mol, such as less than about 1,200,000 g/mol, such as less than about 900,000 g/mol, such as less than about 800,000 g/mol.

The polyethylene may have a viscosity number of from at least 500 mL/g, such as at least 700 mL/g, such as at least 1,000 mL/g, to less than about 6,000 mL/g, such as less than about 5,000 mL/g, such as less than about 4,000 mL/g, such as less than about 3,000 mL/g, such as less than about 2,000 mL/g, as determined according to ISO 1628 part 3 utilizing a concentration in decahydronapthalene of 0.0002 g/mL.

The high density polyethylene may have a crystallinity of from at least about 40% to 85%, such as from 45% to 80%. In one aspect, the crystallinity can be greater than about 50%, such as greater than about 55%, such as greater than about 60%, such as greater than about 65%, such as greater than about 70%, and generally less than about 80%.

When combined with a plasticizer in forming porous films or membranes, the high density polyethylene particles are present in the polymer composition in an amount up to about 50% by weight. For instance, the high density polyethylene particles can be present in the polymer composition in an amount less than about 45% by weight, such as in an amount less than about 40% by weight, such as in an amount less than about 35% by weight, such as in an amount less than about 30% by weight, such as in an amount less than about 25% by weight, such as in an amount less than about 20% by weight, such as in an amount less than about 15% by weight. The polyethylene particles can be present in the composition in an amount greater than about 5% by weight, such as in an amount greater than about 10% by weight, such as in an amount greater than about 15% by weight, such as in an amount greater than about 20% by weight, such as in an amount greater than about 25% by weight.

During gel processing, a plasticizer is combined with the high density polyethylene particles which can be substantially or completely removed in forming polymer articles. For example, in one embodiment, the resulting polymer article can contain one or more high density polyethylene polymers in an amount greater than about 50% by weight, such as in an amount greater than about 60% by weight, such as in an amount greater than about 65% by weight, such as in an amount greater than about 70% by weight, such as in an amount greater than about 75% by weight, such as in an amount greater than about 80% by weight, such as in an amount greater than about 85% by weight, such as in an amount greater than about 90% by weight, such as in an amount greater than about 95% by weight, such as in an amount greater than about 98% by weight, such as in an amount greater than about 99% by weight, such as in an amount greater than about 99.5% by weight.

The plasticizer, for instance, may comprise a hydrocarbon oil, an alcohol, an ether, an ester such as a diester, or mixtures thereof. For instance, suitable plasticizers include mineral oil, a paraffinic oil, decaline, and the like. Other plasticizers include xylene, dioctyl phthalate, dibutyl phthalate, stearyl alcohol, oleyl alcohol, decyl alcohol, nonyl alcohol, diphenyl ether, n-decane, n-dodecane, octane, nonane, kerosene, toluene, naphthalene, tetraline, and the like. In one embodiment, the plasticizer may comprise a halogenated hydrocarbon, such as monochlorobenzene. Cycloalkanes and cycloalkenes may also be used, such as camphene, methane, dipentene, methylcyclopentandiene, tricyclodecane, 1,2,4,5-tetramethyl-1,4-cyclohexadiene, and the like. The plasticizer may comprise mixtures and combinations of any of the above as well.

The plasticizer is generally present in the composition used to form the polymer articles in an amount greater than about 50% by weight, such as in an amount greater than about 55% by weight, such as in an amount greater than about 60% by weight, such as in an amount greater than about 65% by weight, such as in an amount greater than about 70% by weight, such as in an amount greater than about 75% by weight, such as in an amount greater than about 80% by weight, such as in an amount greater than about 85% by weight, such as in an amount greater than about 90% by weight, such as in an amount greater than about 95% by weight, such as in an amount greater than about 98% by weight. In fact, the plasticizer can be present in an amount up to about 99.5% by weight.

In accordance with the present disclosure, the one or more high density polyethylene polymers and one or more plasticizers are combined with a molecular weight retention package. The molecular weight retention package is added in an amount sufficient to improve molecular weight retention during the gel extrusion process. Molecular weight retention, for instance, can be measured by comparing the intrinsic viscosity of the polyethylene polymer prior to gel extrusion to the intrinsic viscosity of the polyethylene polymer after extrusion. The molecular weight retention package of the present disclosure, for instance, can be added to the polymer composition such that the composition displays an intrinsic viscosity retention of greater than about 88%, such as greater than about 90%, such as greater than about 92%, such as even greater than about 94%. These results are dramatic and unexpected.

In one embodiment, the molecular weight retention package comprises the combination of a hindered phenolic compound and a phosphite compound.

One example of a hindered phenolic compound that can be contained within the molecular weight retention package comprises pentaerythritol tetrakis (3-(3,5-di-tert-butyl-4-hydroxyphenyl)propionate).

Examples of other hindered phenolic compounds that may be contained in the molecular weight retention package include, for instance, calcium bis(ethyl 3,5-di-tert-butyl-4-hydroxybenzylphosphonate); terephthalic acid, 1,4-dithio-,S,S-bis(4-tert-butyl-3-hydroxy-2,6-dimethylbenzyl) ester; triethylene glycol bis(3-tert-butyl-4-hydroxy-5-methylhydrocinnamate); hexamethylene bis(3,5-di-tert-butyl-4-hydroxyhydrocinnamate; 1,2-bis(3,5,di-tert-butyl-4-hydroxyhydrocinnamoyphydrazide, 4,4′-di-cert-octyldiphenamine; phosphonic acid, (3,5-di-cert-butyl-4-hydroxybenzyl)-,dioctadecyl ester; 1,3,5-trimethyl-2,4,6-tris(3′,5′-di-tert-butyl-4: hydroxybenzyl)benzene; 2,4-bis(octylthio)-6-(4-hydroxy-3,5-di-tert-butylanilino)-1,3,5-triazine; isooctyl 3-(3,5-di-tert-butyl-4-hydroxyphenyl)propionate; octadecyl 3-(3,5-di-tert-butyl-4-hydroxyphenyl)propionate; 3,7-bis(1,1,3,3-tetramethylbutyl)-1 OH-phenothiazine; 2,2′-methylenebis(4-methyl-6-tart-butylphenol)monoacrylate; 2-tert-butyl-6-[1-(3-tert-butyl-2-hydroxy-5-methylphenyi)ethyl]-4-methylphenyl acrylate; 2-[1-(2-hydroxy-3,5-di-tert-pentylphenyl)ethyl]-4,6-di-tert-pentylphenyl acrylate; 1,3-dihydro-2H-Benzimidazole; 2-methyl-4,6-bis[(octylthio)methyl]phenol; N,N′-trimethylenebis-[3-(3,5-di-tert-butyl-4-hydroxyphenyl)propionamide; 4-n-octadecyloxy-2,6-diphenylphenol; 2,2′-ethylidenebis[4,6-di-Cert-butylphenol]; N N′-hexamethylenebis(3,5-di-tert-butyl-4-hydroxyhydrocinnamamide); diethyl (3,5-di-tert-butyl-4-hydroxybenzyl)phosphonate; 4,4′-di-tert-octyldiphenylamine; N-phenyl-1-naphthalenamine; tris[2-tert-butyl-4-(3-ter-butyl-4-hydroxy-6-methylphenylthio)-5-methyl phenyl]phosphite; zinc dinonyidithiocarbamate; 3,9-bis[1,1-diimethyl-2-[(3-tert-butyl-4-hydroxy-5-methylphenyl)propionyloxy]ethyl]-2,4,8,10-tetraoxaspiro[5.5]undecane; pentaerythrityl tetrakis[3-(3,5-di-tert-butyl-4-hydroxyphenyl)propionate]; ethylene-bis(oxyethylene)bis[3-(5-tert-butyl-4-hydroxy-m-tolyl)-propionate; 3,5-di-tart-butyl-4-hydroxytoluene and so forth.

Some examples of suitable sterically hindered phenolic antioxidants for use in the present composition are triazine antioxidants having the following general formula:

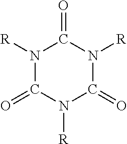

wherein, each R is independently a phenolic group, which may be attached to the triazine ring via a C₁ to C₅ alkyl or an ester substituent. Preferably, each R is one of the following formula (I)-(III)

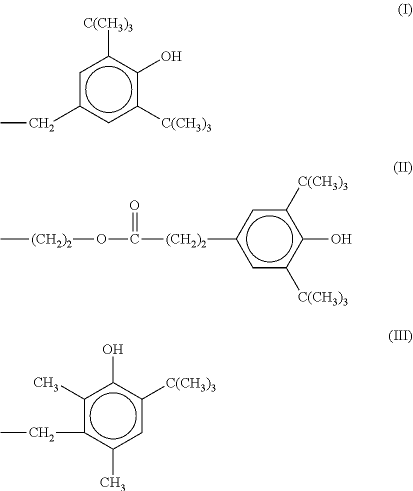

One or more hindered phenolic compounds can be present in the polymer composition generally in an amount greater than 1,000 ppm. For example, one or more hindered phenolic compounds can be present in the polymer composition to be gel extruded (one or more high density polyethylene polymers blended with one or more plasticizers) in an amount generally greater than about 1,200 ppm, such as greater than about 1,400 ppm, such as greater than about 1,600 ppm, such as greater than about 1,800 ppm, such as greater than about 2,000 ppm, such as greater than about 2,200 ppm, such as greater than about 2,400 ppm, such as greater than about 2,600 ppm, such as greater than about 2,800 ppm, such as greater than about 3,000 ppm, such as greater than about 3,200 ppm, such as greater than about 3,400 ppm, such as greater than about 3,600 ppm, such as greater than about 3,800 ppm. One or more hindered phenolic antioxidants are generally present in the polymer composition in an amount less than about 7,000 ppm, such as in an amount less than about 6,000 ppm.

In addition to a phenolic compound, the molecular weight retention package can also contain a phosphite compound. In one embodiment, the phosphite compound comprises 2,2′-methylene bis(4,6-di-tert-butyl-phenyl)-2-ethylhexyl phosphite.

Other phosphite compounds that can be incorporated into the molecular weight retention package include monophosphite compounds, diphosphite compounds, and the like.

Examples of monophosphites are aryl monophosphites that contain C₁ to C₁₀ alkyl substituents on at least one of the aryloxide groups. These substituents may be linear (as in the case of nonyl substituents) or branched (such as isopropyl or tertiary butyl substituents). Non-limiting examples of suitable aryl monophosphites (or monophosphonites) may include triphenyl phosphite; diphenyl alkyl phosphites; phenyl dialkyl phosphites; tris(nonylphenyl) phosphite; tris(2,4-di-tert-butylphenyl) phosphite; bis(2,4-di-tert-butyl-6-methylphenypethyl phosphite; and 2,2′,2″-nitrilo[triethyltris(3,3′5,5-tetra-tert-butyl-1,1′-biphenyl-2,2′-diyl) phosphate. Aryl diphosphites or diphosphonites (i.e., contains at least two phosphorus atoms per phosphite molecule may also be employed in the molecular weight retention package and may include, for instance, distearyl pentaerythritol diphosphite, diisodecyl pentaerythritol diphosphite, bis(2,4 di-tert-butylphenyl) pentaerythritol diphosphite; bis(2,6-di-tert-butyl-4-methylphenyl)pentaerythritol diphosphite; bisisodecyloxypentaerythritol diphosphite, bis(2,4-di-tert-butyl-6-methylphenyl)pentaerythritol diphosphite, bis(2,4,6-tri-tert-butylphenyl)pentaerythritol diphosphite, tetrakis(2,4-di-tert-butylphenyl)4,4′-biphenylene-diphosphonite and bis(2,4-dicumylphenyl)pentaerythritol diphosphite.

One or more phosphite compounds are generally present in the polymer composition to be gel extruded in an amount greater than about 700 ppm. For instance, one or more phosphite compounds can be present in the polymer composition in an amount greater than about 900 ppm, such as in an amount greater than about 1,100 ppm, such as in an amount greater than about 1,300 ppm, such as in an amount greater than about 1,500 ppm, such as in an amount greater than about 1,700 ppm, such as in an amount greater than about 1,900 ppm. In general, one or more phosphite compounds are present in the polymer composition to be gel extruded in an amount less than about 5,000 ppm, such as in an amount less than about 4,000 ppm.

The weight ratio between the phosphite compound and the hindered phenolic compound can vary depending upon the particular application, the polyethylene polymer present in the polymer composition, the plasticizer present in the polymer composition, and the particular phosphite and phenolic compound selected. In one aspect, the weight ratio of the phosphite compound to the phenolic compound can be from about 1:1 to about 1:3. For instance, the ratio can be from about 1:1.5 to about 1:2,5, such as from about 1:1.75 to about 1:2.25.

In the past, it was believed that incorporating copious amounts of a hindered phenolic compound and/or a phosphite compound into a gel processing composition containing a polyethylene polymer would degrade the polymer, cause yellowing, and detrimentally affect the physical strength of the polymer and/or the ability to melt process the polymer. To the contrary, it was discovered that the molecular weight retention package of the present disclosure can be incorporated into a polymer composition for gel extrusion that can dramatically improve molecular weight retention without any detrimental effects. Further, during gel processing, the one or more plasticizers are removed. In accordance with the present disclosure, the plasticizers can be removed in a manner that also removes at least a portion of the molecular weight retention package. In this way, the final article produced through gel extrusion contains the molecular weight retention package at amounts significantly less than the amounts added to the polymer composition prior to gel extrusion. For instance, the final amount in the polymer article can be reduced by greater than about 10%, such as reduced by greater than about 30%, such as reduced by greater than about 50% in comparison to the amount of the molecular weight retention package initially combined with the polymer composition.

As described above, molecular weight retention can be determined through measuring intrinsic viscosity of the polyethylene polymer before and after extrusion. As used herein, intrinsic viscosity is measured according to ISO Test 1628-3 (current test as of 2022). The initial intrinsic viscosity of the polyethylene polymer can be from about 700 cm³/g to about 7,000 cm³/g, including all increments of 1 cm³/g therebetween. In one embodiment, the initial intrinsic viscosity of the polyethylene polymer is from about 800 cm³/g to about 1,200 cm³/g. In an alternative embodiment, the initial intrinsic viscosity of the polyethylene polymer can be from about 1,000 cm³/g to about 3,000 cm³/g. In still another embodiment, the initial intrinsic viscosity of the polyethylene polymer can be from about 3,000 cm³/g to about 6,000 cm³/g. In one particular embodiment, the initial intrinsic viscosity of the polyethylene polymer is greater than about 800 cm³/g, such as greater than about 850 cm³/g, such as greater than about 900 cm³/g, such as greater than about 950 cm³/g, and generally less than about 3,000 cm³/g. In this embodiment, the intrinsic viscosity of the polyethylene polymer after gel extrusion can be greater than about 800 cm³/g, such as greater than about 850 cm³/g, such as greater than about 875 cm³/g, such as greater than about 900 cm³/g, such as greater than about 950 cm³/g, such as greater than about 1,000 cm³/g, such as greater than about 1.500 cm³/g, such as greater than about 2,000 cm³/g, such as greater than about 2,500 cm³/g.

In order to form polymer articles hi accordance with the present disclosure, the high density polyethylene polymer particles are combined with one or more plasticizers and the molecular weight retention package of the present disclosure. In one embodiment, the polymer composition contains only a single high density polyethylene polymer. Alternatively, the polymer composition can contain two or more high density polyethylene polymers.

The high density polyethylene particles, plasticizer, and molecular weight retention package are blended together to form a homogeneous gel-like material and extruded through a die of a desired shape. In one embodiment, the composition can be heated within the extruder. For example, the plasticizer can be combined with the particle mixture and fed into an extruder. The plasticizer and particle mixture form a homogeneous gel-like material prior to leaving the extruder for forming polymer articles with little to no impurities.

In one embodiment, elongated articles are formed during the gel spinning or extruding process. The polymer article, for instance, may be in the form of a fiber or a film, such as a membrane.

During the process, at least a portion of the plasticizer is removed from the final product. The plasticizer removal process may occur due to evaporation when a relatively volatile plasticizer is used. Otherwise, an extraction liquid can be used to remove the plasticizer. The extraction liquid may comprise, for instance, a hydrocarbon solvent. One example of the extraction liquid, for instance, is dichloromethane. Other extraction liquids include acetone, chloroform, an alkane, hexene, heptene, an alcohol, or mixtures thereof. In one embodiment, an extraction liquid is selected that also controls the amount of the molecular weight retention package that is removed from the composition.

If desired, the resulting polymer article can be stretched at an elevated temperature below the melting point of the polyethylene polymer to increase strength and modulus. Suitable temperatures for stretching are in the range of from about ambient temperature to about 155° C. The draw ratios can generally be greater than about 4, such as greater than about 6, such as greater than about 8, such as greater than about 10, such as greater than about 15, such as greater than about 20, such as greater than about 25, such as greater than about 30. In certain embodiments, the draw ratio can be greater than about 50, such as greater than about 100, such as greater than about 110, such as greater than about 120, such as greater than about 130, such as greater than about 140, such as greater than about 150. Draw ratios are generally less than about 1,000, such as less than about 800, such as less than about 600, such as less than about 400. In one embodiment, lower draw ratios are used such as from about 4 to about 10. The polymer article can be uniaxially stretched or biaxially stretched.

Polymer articles made in accordance with the present disclosure have numerous uses and applications. For example, in one embodiment, the process is used to produce a membrane. The membrane or film can be used, for instance, as an ion or battery separator. Alternatively, the membrane can be used as a microfilter. When producing fibers, the fibers can be used to produce nonwoven fabrics, ropes, nets, and the like. In one embodiment, the fibers can be used as a filler material in ballistic apparel.

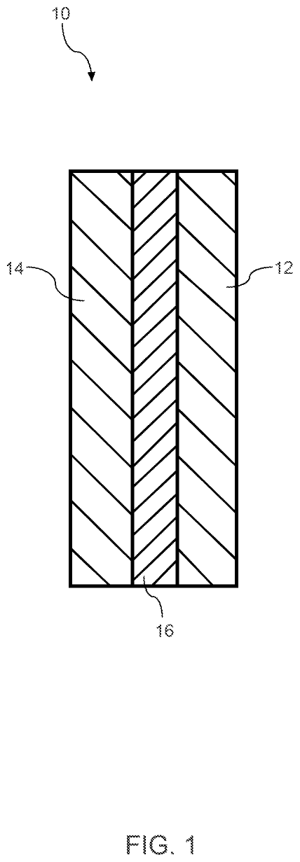

Referring to FIG. 1, one embodiment of a lithium ion battery 10 made in accordance with the present disclosure is shown. The battery 10 includes an anode 12 and a cathode 14. The anode 12, for instance, can be made from a lithium metal. The cathode 14, on the other hand, can be made from sulfur or from an intercalated lithium metal oxide. In accordance with the present disclosure, the battery 10 further includes a porous membrane 16 or separator that is positioned between the anode 12 and the cathode 14. The porous membrane 16 minimizes electrical shorts between the two electrodes while allowing the passage of ions, such as lithium ions. As shown in FIG. 1, in one embodiment, the porous membrane 16 is a single layer polymer membrane and does not include a multilayer structure. In one aspect, the single layer polymer membrane may also include a coating. The coating can be an inorganic coating made from, for instance, aluminum oxide or a titanium oxide. Alternatively, the single layer polymer membrane may also include a polymeric coating. The coating can provide increased thermal resistance.

Porous membranes or films made according to the present disclosure can generally have a thickness of greater than about 5 microns, such as greater than about 6 microns, such as greater than about 7 microns, such as greater than about 8 microns, such as greater than about 9 microns, such as greater than about microns, such as greater than about 11 microns. The thickness of the membranes or films is generally less than about 20 microns, such as less than about 16 microns, such as less than about 14 microns, such as less than about 12 microns, such as less than about 10 microns, such as less than about 8 microns.

Membranes or films made according to the present disclosure can have excellent physical properties. For example, membranes or films having a porosity of from about 35% to about 38% can have a puncture strength of greater than about 1,000 mN/micron, such as greater than about 1,200 mN/micron, such as greater than about 1,400 mN/micron, such as greater than about 1,475 mN/micron, such as greater than about 1,500 mN/micron, such as greater than about 1,525 mN/micron, such as greater than about 1,550 mN/micron, such as greater than about 1,575 mN/micron, such as greater than about 1,600 mN/micron, such as greater than about 1,625 mN/micron, such as greater than about 1,650 mN/micron, and generally less than about 3,000 mN/micron. The pin strength can be greater than about 200 gf/g/cm², such as greater than about 250 gf/g/cm², such as greater than about 252 gf/g/cm², such as greater than about 254 gf/g/cm², such as greater than about 256 gf/g/cm², such as greater than about 258 gf/g/cm², such as greater than about 260 gf/g/cm², such as greater than about 262 gf/g/cm², and generally less than about 300 gf/g/cm².

At a membrane or film porosity of from about 39% to about 50%, the membrane or film can have a puncture strength of greater than about 300 mN/micron, such as greater than about 340 mN/micron, such as greater than about 350 mN/micron, such as greater than about 360 mN/micron, such as greater than about 370 mN/micron, such as greater than about 380 mN/micron, such as greater than about 390 mN/micron, such as greater than about 400 mN/micron, and generally less than about 600 mN/micron and can have a pin strength of greater than about 60 gf/g/cm², such as greater than about 65 gf/g/cm², such as greater than about 72 gf/g/cm², such as greater than about 74 gf/g/cm², such as greater than about 76 gf/g/cm², such as greater than about 78 gf/g/cm², such as greater than about 80 gf/g/cm², such as greater than about 82 gf/g/cm², and generally less than about 150 gf/g/cm².

Membranes or films made according to the present disclosure can also have excellent tensile strength properties in either the machine direction or the cross-machine direction. For instance, in either direction, the membrane or film can have a tensile strength of greater than about 100 MPa, such as greater than about 125 MPa, such as greater than about 140 MPa, such as greater than about 150 MPa, such as greater than about 160 MPa, such as greater than about 162 MPa, such as greater than about 164 MPa, such as greater than about 166 MPa, such as greater than about 168 MPa, such as greater than about 170 MPa, and generally less than about 250 MPa.

Polymer membranes or films made according to the present disclosure can have a Gurley permeability of greater than about 105 sec/100 ml, such as greater than about 150 sec/100 ml, such as greater than about 200 sec/100 ml, such as greater than about 225 sec/100 ml, such as greater than about 250 sec/100 ml, such as greater than about 275 sec/100 ml, such as greater than about 300 sec/100 ml, such as greater than about 325 sec/100 ml, such as greater than about 350 sec/100 ml, such as greater than about 375 sec/100 ml, such as greater than about 400 sec/100 ml, such as greater than about 425 sec/100 ml, such as greater than about 450 sec/100 ml, such as greater than about 475 sec/100 ml, such as greater than about 500 sec/100 ml, such as greater than about 525 sec/100 ml, such as greater than about 550 sec/100 ml, such as greater than about 575 sec/100 ml, such as greater than about 600 sec/100 ml, and generally less than about 1,000 sec/100 ml.

The polymer composition and polymer articles made in accordance with the present disclosure may contain various other additives, such as light stabilizers, UV absorbers, acid scavengers, flame retardants, lubricants, colorants, and the like.

In one embodiment, a light stabilizer may be present in the composition. The light stabilizer may include, but is not limited to, 2-(2′-hydroxyphenyl)-benzotriazoles, 2-hydroxy-4-alkoxybenzophenones, nickel containing light stabilizers, 3,5-di-tert-butyl-4-hydroxybenzoates, sterically hindered amines (HALS), or any combination thereof.

In one embodiment, a UV absorber may be present in the composition in lieu of or in addition to the light stabilizer. The UV absorber may include, but is not limited to, a benzotriazole, a benzoate, or a combination thereof, or any combination thereof.

In one embodiment, a halogenated flame retardant may be present in the composition. The halogenated flame retardant may include, but is not limited to, tetrabromobisphenol A (TBBA), tetrabromophthalic acid anhydride, dedecachloropentacyclooctadecadiene (dechlorane), hexabromocyclodedecane, chlorinated paraffins, or any combination thereof.

In one embodiment, a non-halogenated flame retardant may be present in the composition. The non-halogenated flame retardant may include, but is not limited to, resorcinol diphosphoric acid tetraphenyl ester (RDP), ammonium polyphosphate (APP), phosphine acid derivatives, triaryl phosphates, trichloropropylphosphate (TCPP), magnesium hydroxide, aluminum trihydroxide, antimony trioxide.

In one embodiment, a lubricant may be present in the composition. The lubricant may include, but is not limited to, silicone oil, waxes, molybdenum disulfide, or any combination thereof.

In one embodiment, a colorant may be present in the composition. The colorant may include, but is not limited to, inorganic and organic based color pigments.

In one aspect, an acid scavenger may be present in the polymer composition. The acid scavenger, for instance, may comprise an alkali metal salt or an alkaline earth metal salt. The salt can comprise a salt of a fatty acid, such as a stearate. Other acid scavengers include carbonates, oxides, or hydroxides. Particular acid scavengers that may be incorporated into the polymer composition include a metal stearate, such as calcium stearate. Still other acid scavengers include zinc oxide, calcium carbonate, magnesium oxide, and mixtures thereof.

These additives may be used singly or in any combination thereof. In general, each additive may be present in an amount of at least about 0.05 wt. %, such as at last about 0.1 wt. %, such as at least about 0.25 wt. %, such as at least about 0.5 wt. %, such as at least about 1 wt. % and generally less than about 20 wt. %, such as less than about 10 wt. %, such as less than about 5 wt. %, such as less than about 4 wt. %, such as less than about 2 wt. %. The sum of the wt. % of all of the components, including any additives if present, utilized in the polymer composition will be 100 wt. %.

The present disclosure may be better understood with reference to the following example. The following example is given below by way of illustration and not by way of limitation. The following experiments were conducted in order to show some of the benefits and advantages of the present invention.

### Example No. 1

Polymer compositions were formulated in accordance with the present disclosure and fed through a gel extrusion process to produce a porous membrane or film well suited for use as an ion separator in an electronic device, such as a battery. The polymer compositions were formulated containing a molecular weight retention package in accordance with the present disclosure. For purposes of comparison, a similar polymer composition was formulated not containing the molecular weight retention package. The intrinsic viscosity of the polyethylene polymer used to produce the membranes was then determined before and after extrusion.

The high density polyethylene polymer used to produce the samples had an average molecular weight of 1,700,000 g/mol and had an average particle size (d50) of 135 microns. The polymer had a density of 940 kg/m 3.

The polyethylene polymer particles were combined with a plasticizer that comprised a paraffin oil. The plasticizer was added to the polymer composition in an amount of 68% by weight.

Sample No. 1 only contained the plasticizer and high density polyethylene polymer. Sample Nos. 2 and 3 were formulated to contain a molecular weight retention package as follows:

| | Amount of 2,2′-methylene | Amount of pentaerythritol |
|---|---|---|
| | bis(4,6-di-tert-butyl-phenyl)- | tetrakis (3-(3,5-di-tert-butyl- |
| Sample | 2-ethylhexyl phosphite | 4-hydroxyphenyl)propionate) |
| No. | (ppm) | (ppm) |
| 2 | 500 | 1,000 |
| 3 | 2,000 | 4,000 |

The compositions were formed into a porous polymer film via gel extrusion, biaxially stretching, and solvent extraction. The feed rate was 2.0 kg/h. The extrusion temperature was 210° C. at a screw speed of 200 rpm.

After extrusion, the resulting porous polymer film was solidified on a chill roller set to 40° C. Stretching was performed in a 7×7 ratio (MD/TD) at a temperature of 120° C. Extraction of the stretched film was performed in hexane. The porous polymer films were annealed at 130° C. for 10 minutes.

The polyethylene polymer was then measured for intrinsic viscosity according to ISO Test 1628, part 3 before and after extrusion. Intrinsic viscosity retention was calculated as follows:

IV retention=100/IV of pre-extruded polyethylene polymer*IV of extruded polyethylene polymer

The following results were obtained:

| | | | | | IV | IV | IV |
|---|---|---|---|---|---|---|---|
| | IV | IV gel | IV gel | IV gel | retention | retention | retention |
| | pre- | sheet of | sheet of | sheet of | % | % | % |
| | extruded | Sample | Sample | Sample | (Sample | (Sample | (Sample |
| | resin | No. 1 | No. 2 | No. 3 | No. 1) | No. 2) | No. 3) |
| | 907 | 779 | 812 | 828 | 86 | 90 | 91 |
| | 946 | 826 | 870 | 923 | 87 | 92 | 98 |
| | 952 | 824 | 835 | 894 | 87 | 88 | 94 |
| | 966 | 818 | 842 | 922 | 85 | 87 | 95 |
| Average | | | | | 86 | 89 | 95 |

As shown, the molecular weight retention package of the present disclosure had dramatic results in preserving the molecular weight of the polyethylene polymer during gel extrusion.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims

What is claimed:

1. A polymer composition for producing gel extruded articles comprising:
high density polyethylene particles;
a plasticizer; and
a molecular weight retention package comprising a hindered phenolic compound in combination with a phosphite compound, and wherein the molecular weight retention package is present in the composition in an amount sufficient such that an extracted porous membrane gel extruded from the composition displays an intrinsic viscosity retention of greater than about 88% in comparison to the intrinsic viscosity of the high density polyethylene polymer prior to extrusion.

2. A polymer composition as defined in claim 1, wherein the molecular weight retention package is present in the composition in an amount sufficient so that an extracted porous membrane gel extruded from the composition displays an intrinsic viscosity retention of greater than about 90% in comparison to the intrinsic viscosity of the high density polyethylene polymer prior to extrusion.

3. A polymer composition as defined in claim 1, wherein the phosphite compound is present in the composition in an amount greater than about 500 ppm.

4. A polymer composition as defined in claim 1, wherein the hindered phenolic compound is present in the polymer composition in an amount greater than about 1,000 ppm.

5. A polymer composition as defined in claim 1, wherein the phosphite compound is present in the composition in an amount greater than about 700 ppm and less than about 5,000 ppm.

6. A polymer composition as defined in claim 1, wherein the hindered phenolic compound is present in the polymer composition in an amount greater than about 1,200 ppm and less than about 7,000 ppm.

7. A polymer composition as defined in claim 1, wherein the phosphite compound is present in relation to the hindered phenolic compound at a weight ratio of from about 1:1 to about 1:3.

8. A polymer composition as defined in claim 1, wherein the hindered phenolic compound comprises pentaerythritol tetrakis (3-(3,5-di-tert-butyl-4-hydroxyphenyl)propionate).

9. A polymer composition as defined in claim 1, wherein the phosphite corn pound comprises 2,2′-methylene bis(4,6-di-tert-butyl-phenyl)-2-ethylhexyl phosphite.

10. A polymer composition as defined in claim 1, wherein the high density polyethylene polymer has a molecular weight of greater than about 300,000 g/mol and less than about 12,000,000 g/mol.

11. A polymer composition as defined in claim 1, wherein the plasticizer comprises a mineral oil, a paraffinic oil, a hydrocarbon, an alcohol, an ether, an ester, or mixtures thereof.

12. A polymer composition as defined in claim 1, wherein the plasticizer comprises plasticizer comprises decaline, paraffin oil, white oil, mineral oil, xylene, dioctyl phthalate, dibutyl phthalate, stearyl alcohol, oleyl alcohol, decyl alcohol, nonyl alcohol, diphenyl ether, n-decane, n-dodecane, octane, nonane, kerosene, toluene, naphthalene, tetraline, monochlorobenzene, camphene, dipentene, methylcyclopentadiene, tricyclodecane, 1,2,4,5-tetramethyl-1,4-cyclohexadiene, or mixtures thereof.

13. A polymer composition as defined in claim 1, wherein the composition contains one or more plasticizers in an amount greater than about 50% by weight and wherein the polymer composition contains high density polyethylene particles in an amount less than about 50% by weight and in an amount greater than about 20% by weight.

14. An ion separator made from the polymer composition as defined in claim 1, the ion separator comprising a porous membrane, the porous membrane having been extracted to remove the plasticizer, the porous membrane containing one or more high density polyethylene polymers in an amount greater than about 70% by weight.

15. An ion separator as defined in claim 14, wherein the porous membrane has a thickness of from about 4 microns to about 25 microns and has a porosity of from about 20% to about 50%.

16. An ion separator as defined in claim 14, wherein the ion separator is a single layer porous membrane that may optionally include a coating.

17. An ion separator as defined in claim 16, wherein the single layer porous membrane includes a coating, the coating comprising an inorganic coating or a polymer coating.

18. An ion separator as defined in any of claim 14, wherein the ion separator is polypropylene-free.

19. A process for producing a porous membrane comprising:
forming the polymer composition as defined in claim 1 into a gel-like composition; and
extruding the gel-like composition through a die to form a membrane, the membrane being subjected to an extraction for removing the plasticizer, the membrane being biaxially stretched.

20. An ion separator for dividing an anode from a cathode comprising:
a porous polymer membrane, the porous polymer membrane comprising a high density polyethylene polymer having a number average molecular weight of greater than about 300,000 g/mol, the membrane having a thickness of from about 4 microns to about 25 microns and having a porosity of from about 25% to about 45%, the porous membrane containing a molecular weight retention package comprising a hindered phenolic compound and a phosphite compound, the porous membrane having been gel extruded and wherein the high density polyethylene contained in the porous membrane displays an intrinsic viscosity retention of greater than about 88% in comparison to the intrinsic viscosity of the high density polyethylene prior to extruding, the high density polyethylene having an intrinsic viscosity of greater than about 850 cm³/g.
